(19) United States
(12) Patent Application Publication
(10) Pub. No.: US 2010/0103700 A1
(43) Pub. Date: Apr. 29, 2010

(54) Light source module

(76) Inventor: Chih-Jen Tsang, Hsin-Chu (TW)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/588,280

(22) Filed: Oct. 9, 2009

(30) Foreign Application Priority Data
Oct. 23, 2008 (TW) 097140692

(51) Int. Cl. F21V 8/00; G02F 1/29; F21V 5/04

(52) U.S. Cl. 362/618; 359/316; 362/318; 362/617

(57) ABSTRACT

A light source module includes at least one light emitting device and a focus adjustable lens array. The light emitting device is adapted to emit a light beam, the focus adjustable lens array is disposed in the transmission path of the light beam and includes a plurality of focus adjustable lenses arranged in an array. Each of the focus adjustable lenses includes a first light transmissive plate disposed in the transmission path of the light beam, a first electrode disposed on a peripheral area of the first light transmissive plate, a second light transmissive plate disposed in the transmission path of the beam, a second electrode disposed on a peripheral area of the second light transmissive plate, and a focus adjustable solution disposed between the first light transmissive plate and the second light transmissive plate. The focus adjustable solution includes a solvent and an electrotaxis solute.

### CROSS-REFERENCE TO RELATED APPLICATION

This application claims the priority benefit of Taiwan application serial no. 097140692, filed on Oct. 23, 2008. The entirety of the above-mentioned patent application is incorporated herein by reference and made a part of this specification.

### BACKGROUND OF THE INVENTION

1. Field of the Invention

The present invention relates to a light source module, and more particularly, to a light source module having a focus adjustable lens array.

2. Description of Prior Art

FIG. 1 is a profile diagram of a conventional light source module. Referring to the FIG. 1, the conventional light source module 100 includes a light guide plate 110, a cold cathode fluorescent lamp (CCFL) 120, a reflector 130, and a diffusion plate 140. The light guide plate 110 includes a first surface 112, a second surface 114 opposite to the first surface 112, and a light incident surface 116 connecting the first surface 112 and the second surface 114. The CCFL 120 is disposed beside the light incident surface 116, and the CCFL 120 is adapted to emit a light beam 122 towards the light incident surface 116. A part of the light beam 122a is transmitted to the reflector 130 by the light diffusion of the micro concave dots 114a on the second surface 114. The reflector 130 may reflect the part of the light beam 122a, and then may make the part of the light beam 122a pass through the second surface 114, the first surface 112, and the diffusion plate 140 in sequence. On the other hand, another part of the light beam 122b is transmitted to the first surface 112 by the light diffusion of the micro concave dots 114a and then the another part of the light beam 122b may pass through the first surface 112 and the diffusion plate 140 in sequence. The light beam 112 including the part of the light beam 112a and the another part of the light beam 112b may form a surface light source after passing through the diffusion plate 140.

Because the formation of the surface light source may depend on the light diffusion of the micro concave dots 114a, the distribution of the micro concave dots 114a on the second surface 114 may decide the light intensity distribution of the surface light source. However, when the light guide plate 110 is made, the distribution of the micro concave dots 114a on the second surface 114 is fixed and may not be changed, such that when the conventional light source module 100 is in use, the light intensity distribution of the surface light source may not be adjusted upon the requirements, and the application of the light source module 100 may be limited. In addition, when the light source module 100 needs to revise, the micro concave dots 114a on the light guide plate 110 also need to change the form and the ink proportion, so as to not only consume quite a little time for design and manufacturing, but also increase the cost.

### SUMMARY OF THE INVENTION

The present invention is directed to provide a light source module, and the light intensity distribution of a surface light source provided by the light source module may be adjusted upon the requirement.

In an embodiment of the present invention, a light source module including at least one light emitting device and a focus adjustable lens array is provided. The light emitting device is adapted to emit a light beam, and the focus adjustable lens array is disposed in the transmission path of the light beam. The focus adjustable lens array includes a plurality of focus adjustable lenses arranged in an array. Each of the focus adjustable lenses includes a first light transmissive plate, a first electrode, a second transmissive plate, a second electrode, and a focus adjustable solution. The first light transmissive plate is disposed in the transmission path of the light beam. The first electrode is disposed on a peripheral area of the first light transmissive plate, wherein the peripheral area of the first light transmissive plate circles the central area of the first light transmissive plate. The second light transmissive plate is disposed in the transmission path of the light beam, and the distance from the light emitting device to the second light transmissive plate is shorter than the distance from the light emitting device to the first light transmissive plate. The second electrode is disposed on a peripheral area of the second light transmissive plate, wherein the peripheral area of the second light transmissive plate circles the central area of the second light transmissive plate. The focus adjustable solution is disposed between the first light transmissive plate and the second light transmissive plate. The focus adjustable solution includes a solvent and an electrotaxis solute. The electrotaxis solute is mixed into the solvent, wherein the electrotaxis of the electrotaxis solute is greater than the electrotaxis of the solvent, and an absolute value of the difference between the refractive index of the electrotaxis solute and the refractive index of the solvent is greater than zero. When a voltage is applied to the first electrode and the second electrode, an electric field through the focus adjustable solution is generated, and the electrotaxis solute is adjacent from the weak electric field to the strong electric field.

In an embodiment of the present invention, the electrotaxis solute of each of the focus adjustable lenses includes a liquid crystal, a sodium ion or a chlorine ion. The solvent of each of the focus adjustable lenses may include an organic monomer. The light source module further includes a light guide plate disposed in the transmission path of the light beam. The light guide plate has a first surface facing towards the focus adjustable lens array, a second surface opposite to the first surface, and a light incident surface connecting the first surface and the second surface, wherein the light beam may be incident into the light guide plate through the light incident surface, the light beam is capable of exiting the light guide plate through the first surface, and the light beam is transmitted into the focus adjustable lens array. The light source module further includes an optical film, disposed in the transmission path of the light beam, and the light beam is capable of passing through the light guide plate and then passing through the optical film. The optical film includes at least one of a brightness enhancement film and a diffusion plate.

In an embodiment of the present invention, the light emitting device includes a plurality of light emitting devices, and the shortest distance from each of the light emitting devices to the focus adjustable lens array is along a direction substantially perpendicular to the focus adjustable lens array. The light source module further includes a diffusion plate, disposed in the transmission path of the light beam, wherein the focus adjustable lens array is disposed on the diffusion plate. The light source module further includes an optical film, disposed in the transmission path of the light beam, wherein the optical film includes at least one of a brightness enhancement film and a diffusion plate. In each of the focus adjustable lenses, the first electrode is disposed between the first light transmissive plate and the focus adjustable solution, the second electrode is disposed between the second light transmissive plate and the focus adjustable solution, and the second electrode may be disposed between the first electrode and the second light transmissive plate.

In an embodiment of the present invention, in at least one of the focus adjustable lenses, the first electrode surrounds the central area of the first light transmissive plate, and the second electrode surrounds the central area of the second light transmissive plate. In an embodiment of the present invention, in at least one of the focus adjustable lenses, the first electrode is disposed on a part of the peripheral area of the first light transmissive plate and does not surround the central area of the first light transmissive plate, and the second electrode is disposed on a part of the peripheral area of the second light transmissive plate and does not surround the central area of the second light transmissive plate. The first electrode and the second electrode are each a light transmissive electrode.

In an embodiment of the present invention, in each of the focus adjustable lenses, the first light transmissive plate has a third surface facing towards the focus adjustable solution and a fourth surface opposite to the third surface, the second transmissive plate has a fifth surface facing towards the focus adjustable solution and a sixth surface opposite to the fifth surface, and at least one of the third surface, the fourth surface, the fifth surface, and the sixth surface is a curved surface.

In an embodiment of the present invention, in each of the focus adjustable lenses, the first transmissive plate has a third surface facing towards the focus adjustable solution and a fourth surface opposite to the third surface, the second transmissive plate has a fifth surface facing towards the focus adjustable solution and a sixth surface opposite to the fifth surface, and at least one of the third surface, the fourth surface, the fifth surface, and the sixth surface is a plane surface.

In an embodiment of the present invention, in each of the focus adjustable lenses, the electrotaxis solute includes a liquid crystal, and each of the focus adjustable lenses further includes a first orientation film and a second orientation film. The first orientation film is disposed between the first light transmissive plate and the focus adjustable lens. The second orientation film is disposed between the second light transmissive plate and the focus adjustable lens. In each of the focus adjustable lenses, an absolute value of the difference between the refractive index of the electrotaxis solute and the refractive index of the solvent is less than or equal to 1.5. The light source module further includes a voltage control unit, electrically connected to the first electrodes and the second electrodes of the focus adjustable lens.

Following the above mentioned embodiment, the light source module in the embodiment of the present invention adopts the focus adjustable lens array having the focus adjustable solution. When the light intensity distribution of the surface light source provided by the light source module needs to change according to the users' requirements or the revision of the light source module, a voltage applied between the first electrode and the second electrode may be respectively changed, and the distribution of the electrotaxis solute in the focus adjustable solution is changed, so as to change the refractive index of the focus adjustable solution. As a result, the light intensity distribution of the surface light source may be changed, and the light source module in the embodiment of the present invention has an efficacy of adjusting the light intensity distribution on real-time.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a profile diagram of a conventional light source module;

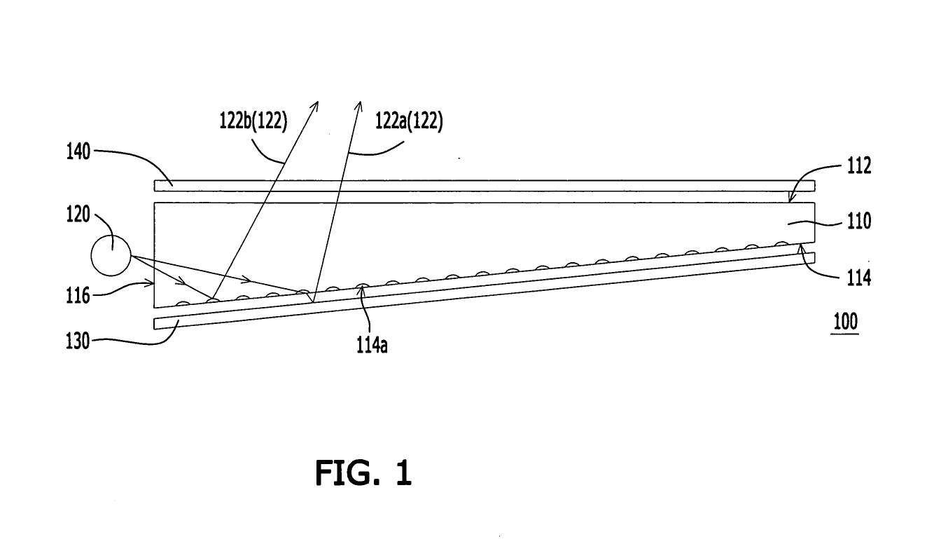

FIG. 2A is a structural diagram of a light source module according to an embodiment of the present invention;

FIG. 2B is three-dimensional view of a focus adjustable lens array of FIG. 2A;

FIG. 2C is a profile diagram of the focus adjustable lens of FIG. 2A when no voltage is applied;

FIG. 2D is a profile diagram of the focus adjustable lens of FIG. 2A when a voltage is applied;

FIG. 3A is a profile diagram of a focus adjustable lens of a light source module according to another embodiment of the present invention when a voltage is applied;

FIG. 3B is a positive diagram of a first transmissive plate and a third surface of the focus adjustable lens of FIG. 3A;

FIG. 4 is a profile diagram of a focus adjustable lens of a light source module according to another embodiment of the present invention when no voltage is applied;

FIG. 5 is a profile diagram of a focus adjustable lens of a light source module according to another embodiment of the present invention when no voltage is applied;

FIG. 6 is a structural diagram of a light source module according to another embodiment of the present invention;

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component directly or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

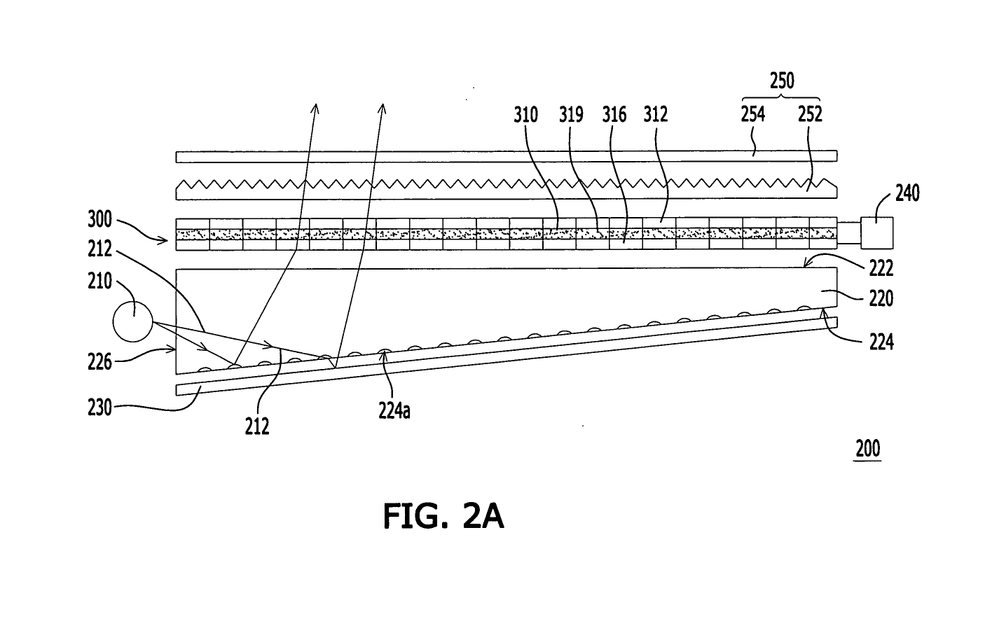

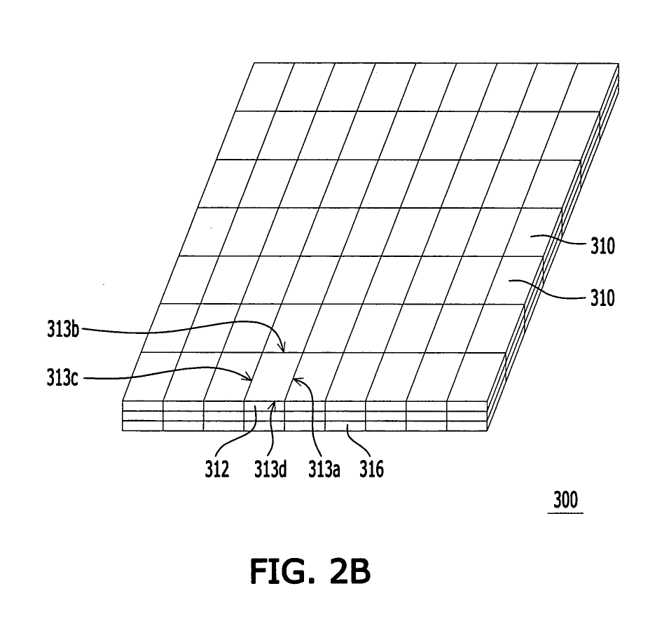

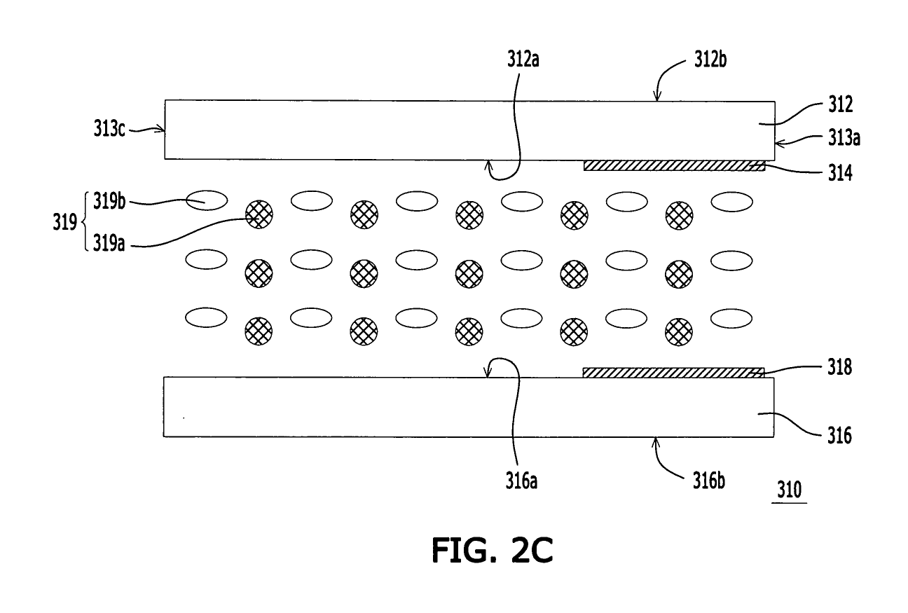

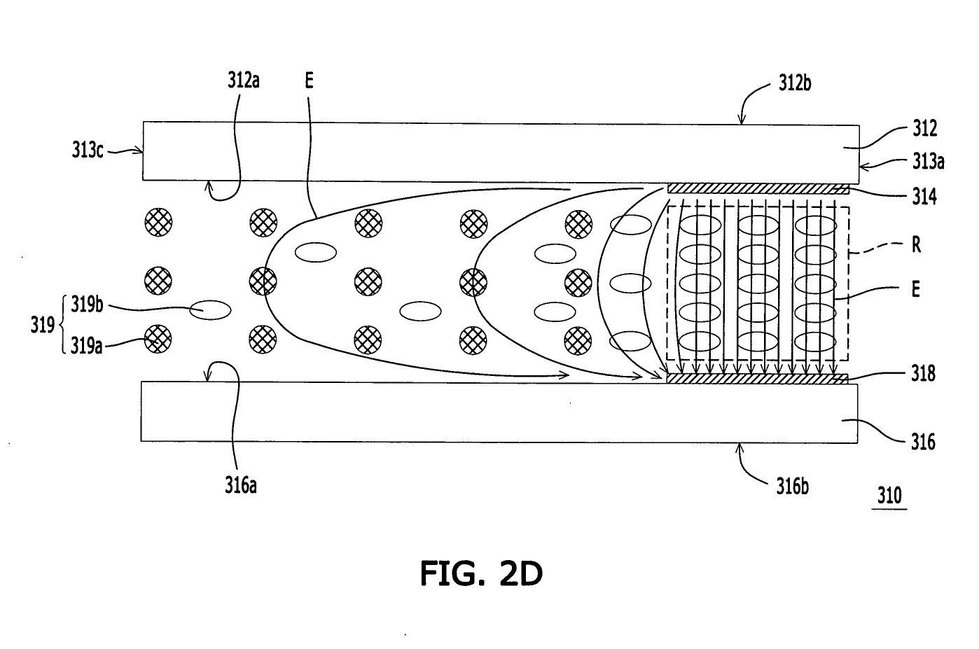

FIG. 2A is a structural diagram of a light source module according to an embodiment of the present invention. The embodiment of the present invention of a light source module 200 includes a light emitting device 210 and a focus adjustable lens array 300. The light emitting device 210 is adapted to emit a light beam 212. In the embodiment of the present invention, the light emitting device 210 is such as a cold cathode fluorescent lamp (CCFL). However, in another embodiment of the present invention, the quantity of the light emitting device may be multiple, and the light emitting devices are a plurality of light emitting diodes (LEDs), for example. In another embodiment of the present invention, the light emitting device may also be another lamp or another suitable light emitting device. The focus adjustable lens array 300 is disposed in the transmission path of the light beam 212. In the embodiment of the present invention, the light source module 200 further includes a light guide plate 220 disposed in the transmission path of the light beam 212. The light guide plate 220 has a first surface 222 facing towards the focus adjustable lens array 300, a second surface 224 opposite to the first surface 222, and a light incident surface 226 connecting the first surface 222 and the second surface 224. The light beam 212 from the light emitting device 210 is incident into the light guide plate 220 through the light incident surface 226, the light beam 212 is capable of exiting the light guide plate 200 through the first surface 222, and the light beam 212 is transmitted to the focus adjustable lens array 300.

In the embodiment of the present invention, a plurality of optical micro structures 224a may be disposed on the second surface 224 of the light guide plate 220, so as to make the light beam 212 to diffuse, and the optical micro structures 224a are concave dots on the second surface 224, for example. However, in another embodiment of the present invention, the optical micro structures 224a may also be a plurality of convex dots, a plurality of concave lines, a plurality of convex lines, a prismatic structure or a plurality of dots constructed by the diffusion material or another suitable optical micro structure. In addition, in another embodiment of the present invention, the optical micro structures 224a may also be disposed on the first surface 222. Furthermore, in the embodiment of the present invention, a reflector 230 is disposed on a side of the second surface 224 for reflecting a part of the light beam 212 to the first surface 222

FIG. 2B is three-dimensional view of a focus adjustable lens array of FIG. 2A, and FIG. 2C is a profile diagram of the focus adjustable lens of FIG. 2A when no voltage is applied. Referring from the FIG. 2A to the FIG. 2C, the focus adjustable lens array 300 includes a plurality of focus adjustable lenses 310, and the focus adjustable lenses 310 are arranged in an array. In the embodiment of the present invention, the focus adjustable lenses 310 may be arranged substantially parallel to the first surface 222 with each other (shown as FIG. 2A). Each of the focus adjustable lenses 310 includes a first light transmissive plate 312, a first electrode 314, a second light transmissive plate 316, a second electrode 318, and a focus adjustable solution 319. The first light transmissive plate 312 is disposed in the transmission path of the light beam 212. The first electrode 314 is disposed on a peripheral area of the first light transmissive plate 312, wherein the peripheral area of the first light transmissive plate 312 circles the central area of the first light transmissive plate 312. In the embodiment of the present invention, the first electrode 314 is disposed on a part of the peripheral area of the first light transmissive plate 312 and does not surround the central area of the first light transmissive plate 312. Specifically speaking, the first transmissive plate 312 includes four edges 313a, 313b, 313c, and 313d, and the first electrode 314 may be disposed on the edge 313a and may not be disposed on the edge 313b, 313c or 313d. The second light transmissive plate 316 is disposed in the transmission path of the light beam 212, and the distance from the light emitting device 210 to the second light transmissive plate 316 is shorter than the distance from the light emitting device 210 to the first light transmissive plate 312. The second electrode 318 may be disposed on a peripheral area of the second light transmissive plate 316, wherein the peripheral area of the light transmissive plate 316 circles the central area of the second light transmissive plate 316. In the embodiment of the present invention, the second electrode 318 may be disposed on the relative position of the edge of the first electrode 314. In addition, the second electrode 318 may be disposed on one of the four edges of the second transmissive plate 316. In another embodiment of the present invention, the focus adjustable lenses 310 are not only limited to having four edges and may also be formed into any shape manufactured according to the requirement of design. Furthermore, the first electrodes 314 and the second electrodes 318 of the focus adjustable lens array 300 are electrically connected to a voltage control unit 240, the voltage control unit 240 may generate a voltage between the first electrode 314 and the second electrode 318, and the voltage control unit 240 may also respectively control the voltage applied to the different focus adjustable lenses 310 of the focus adjustable lens array 300.

The focus adjustable lens solution 319 is between the first light transmissive plate 312 and the second light transmissive plate 316. The focus adjustable lens solution 319 includes a solvent 319a and an electrotaxis solute 319b, wherein the electrotaxis solute 319b is mixed into the solvent 319a. The electrotaxis of the electrotaxis solute 319b is greater than the electrotaxis of the solvent 319a. In other words, the electrotaxis solute 319b moves to the strong electric field more easily than the solvent 319a does. In addition, an absolute value of the difference between the refractive index of the electrotaxis solute 319b and the refractive index of the solvent 319a is greater than zero. In the embodiment of the present invention, the absolute value of the difference between the refractive index of the electrotaxis solute 319b and the refractive index of the solvent 319a is less than or equal to 1.5. Specifically speaking, the electrotaxis solute 319b is such as a liquid crystal, the solvent 319a is such as an organic monomer, and the refractive index of the electrotaxis solute 319b is greater than the refractive index of the solvent 319a. However, in another embodiment of the present invention, the electrotaxis solute 319b may also be at least one of a sodium ion, a chlorine ion, and other solute. In addition, in another embodiment of the present invention, the solvent 319a may also be at least one of other organic solvent and other inorganic solvent. Furthermore, in another embodiment of the present invention, the refractive index of the electrotaxis solute may also be less than the refractive index of the solvent.

In the embodiment of the present invention, the first electrode 314 is disposed between the first transmissive plate 312 and the focus adjustable solution 319. The second electrode 318 is disposed between the second transmissive plate 316 and the focus adjustable solution 319, and the second electrode 318 is disposed between the first electrode 314 and the second transmissive plate 316. In other words, the second electrode 318 may be disposed on the position of the second transmissive plate 316 relative to the first electrode 314. Furthermore, in the embodiment of the present invention, the first electrode 314 and the second electrode 318 are transmissive electrodes. In addition, the first transmissive plate 312 has a third surface 312a facing towards the focus adjustable solution 319 and a fourth surface 312b opposite to the third surface 312a. The second transmissive plate 316 has a fifth surface 316a facing towards the focus adjustable solution 319 and a sixth surface 316b opposite to the fifth surface 316a. The third surface 312a, the fourth surface 312b, the fifth surface 316a, and the sixth surface 316b are plane surfaces.

FIG. 2D is a profile diagram of the focus adjustable lens of FIG. 2A when a voltage is applied. Referring to FIG. 2C, when no voltage is applied between the first electrode 314 and the second electrode 318, the electrotaxis solute 319b evenly distributes in the focus adjustable solution 319. Referring to FIG. 2D again, when a voltage is applied between the first electrode 314 and the second electrode 318, an electric field E through the focus adjustable solute 319 may be generated, wherein the strong place of the electric field has more electric lines, and the weak place of the electric field has less electric lines. Furthermore, the electrotaxis solute 319b is adjacent from the weak place of the electric field E to the strong place of the electric field E. In the embodiment of the present invention, the electric field E of a area R between the first electrode 314 and the second electrode 318 is stronger, such that the electrotaxis solute 319b may be close to the area R. The concentration of the electrotaxis solute 319b of the area R in the focus adjustable solution 319 is higher. In addition, the concentration of the electrotaxis solute 319b in the focus adjustable solution 319 is capable of reducing from the place near to the area R to the place far away from the area R. In the embodiment of the present invention, because the refractive index of the electrotaxis solute 319b is greater than the refractive index of the solvent 319a, the concentration distribution of the electrotaxis solute 319b may cause the refractive index of the focus adjustable solution 319 in the area R to be higher and cause the refractive index of the solution 319 in the area far away from the area R to be lower. As a result, the focus adjustable solution 319 may be able to cause the focus adjustable lens 310 to have an effect similar to a curved surface lens.

Referring to FIGS. 2A and 2D, since the refractive index of the focus adjustable solution 319 is reduced from a side to another side of the focus adjustable lens 310, when a suitable voltage is applied between the first electrode 314 and the second electrode 318, the focus adjustable lens array 300 may have an effect similar to a prism sheet, and the range of the light emitting angle reduces after the light beam 212 through the focus adjustable lens array 300.

When the light intensity distribution of the surface light source provided by the light source module 200 needs to change according to the users' requirements or the revision of the light source module 200, a voltage applied between the first electrode 314 and the second electrode 318 of the focus adjustable lens 310 may be changed respectively, and the distribution of the electrotaxis solute 319b in the focus adjustable solution 319 may be changed, so as to change the distribution of the refractive index of the focus adjustable solution 319. As a result, the light intensity distribution of the surface light source may be changed, so that the light source module 200 in the embodiment of the present invention has an efficacy of adjusting the light intensity distribution on real-time. Therefore, the light source module 200 may be adjusted according to the users' requirements, and different light emitting types of light source modules may not be purchased additionally. In addition, when the light source module 200 revises, the distribution of the optical micro structures 224a on the light guide plate 220 may not need to redesign, and only the voltage applied between the first electrode 314 and the second electrode 318 needs to change. In this way, the design cost and the time of design and manufacturing for the revised light source module 200 are reduced.

Referring to FIG. 2A, the light source module 200 further includes an optical film 250 disposed in the transmission path of the light beam 212, wherein the light beam 212 is capable of passing through the light guide plate 220 and then passing through the optical film 250. The optical film 250 includes a brightness enhancement film 252 and a diffusion plate 254. However, in another embodiment of the present invention, the optical film 250 may also include one of the brightness enhancement film 252 and the diffusion plate 254 or may include other suitable optical film. The optical film 250 may further adjust the light emitting angle of the light beam 212 to make the light source module 200 be able to provide a more suitable surface light source. However, in another embodiment of the present invention, the light source module 200 also may not have the optical film 250.

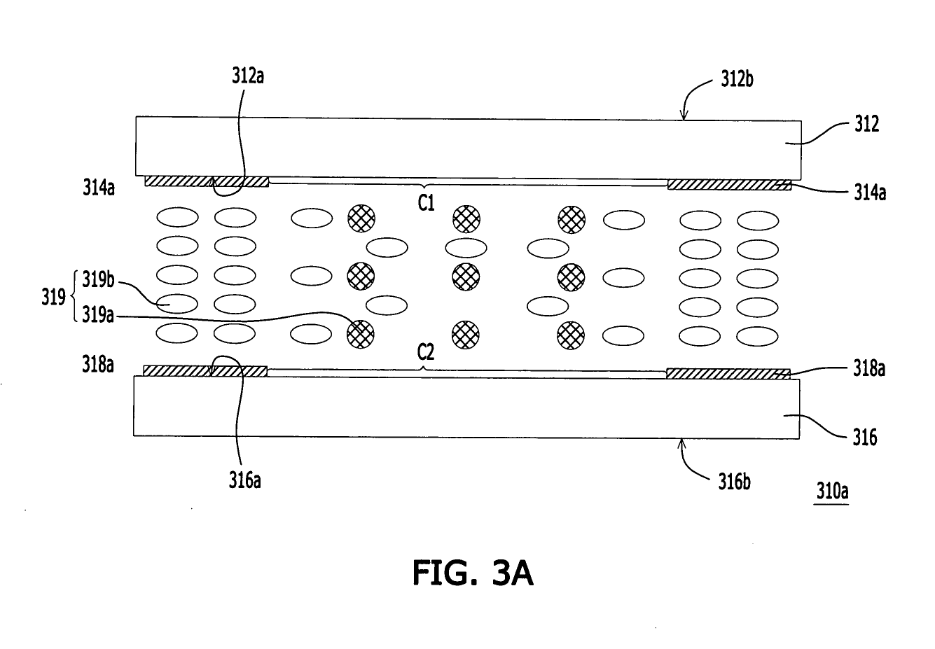

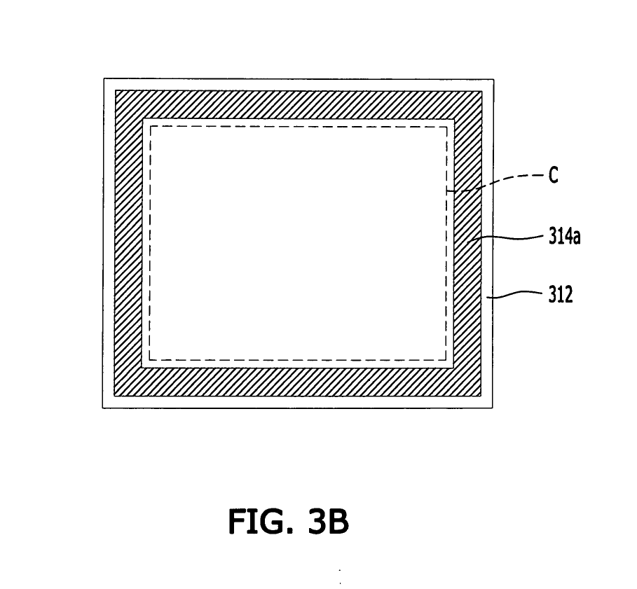

FIG. 3A is a profile diagram of a focus adjustable lens 310a of a light source module according to another embodiment of the present invention when a voltage is applied, and FIG. 3B is a positive diagram of a first transmissive plate and a third surface of the focus adjustable lens of FIG. 3A. Referring to FIG. 3A and FIG. 3B, the focus adjustable lens 310a of the embodiment of the present invention is similar to the above mentioned focus adjustable lens 310 (shown as FIG. 2D), and the differences between the both are described below. In the focus adjustable lens 310a, the first electrode 314a surrounds the central area C1 of the first transmissive plate 312. In addition, the second electrode 318a surrounds the central area C2 of the second transmissive plate 316. When a voltage is applied between the first electrode 314a and the second electrode 318a, the concentration of the electrotaxis solute 319b in the focus adjustable solution 319 may be reduced from the peripheral area to the central area of the focus adjustable lens 310a. In the embodiment of the present invention, the refractive index of the focus adjustable solution 319 may be reduced from the peripheral area to the central area of the focus adjustable lens 310a, and an effect similar to a concave lens may be generated. The focus adjustable lens array arranged by the focus adjustable lens 310a has an effect similar to the diffusion plate, and the focus adjustable lens array arranged by the focus adjustable lens 310a may diffuse the light beam. In the embodiment of the present invention, the first electrode 314a and the second electrode 318a are square-type rings; however, in another embodiment of the present invention, the first electrode and the second electrode may also be circle-type rings or other rings with other types.

Notably, the focus adjustable lens array of the embodiment of the present invention may be arranged by the above mentioned focus adjustable lens 310 (shown as FIG. 2D), and the focus adjustable lens array of the embodiment of the present invention may also be arranged by the focus adjustable lens 310a (shown as FIG. 3A), and the invention is not limited to the above mentioned focus adjustable lens array. In another embodiment of the present invention, the focus adjustable lens array may be arranged by the focus adjustable lens 310 and the focus adjustable lens 310a at the same time. In another embodiment of the present invention, the focus adjustable lens 310 and the focus adjustable lens 310a may be arranged alternately, to form a focus adjustable lens array.

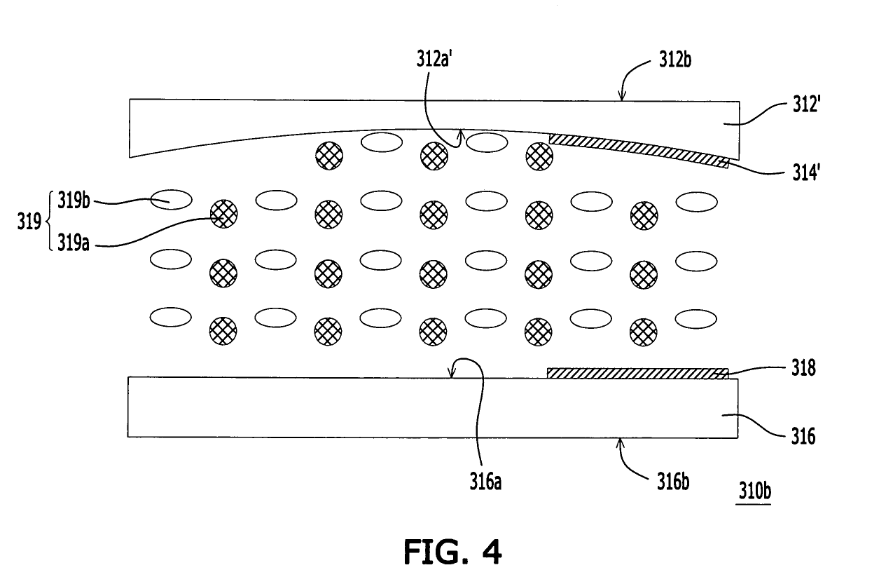

FIG. 4 is a profile diagram of a focus adjustable lens of a light source module according to another embodiment of the present invention when no voltage is applied. Referring to FIG. 4, the focus adjustable lens 310b of the embodiment of the present invention is similar to the above mentioned focus adjustable lens 310 (shown as FIG. 2D), and the differences between the both are described below. In the focus adjustable lens 310b, the third surface 312a′ of the first transmissive plate 312′ is a curved surface. Specifically speaking, the third surface 312a′ is a concave surface, for example, and the first electrode 314′ is curved as the third surface 312a′ is curved. As a result, the absolute value of the refractive power of the focus adjustable lens 310b is greater after a voltage is applied.

Notably, in the embodiment of the present invention, the third surface and the fourth surface of the first transmissive plate, and the fifth surface and the sixth surface of the second transmissive plate may be each a curved surface or a plane surface. In other words, the four surfaces may be all curved surfaces or all plane surfaces. Besides, a part of the four surfaces may be curved surfaces, and another part of the four surfaces may be plane surfaces. In addition, the above mentioned curved surface may be a concave surface or a convex surface.

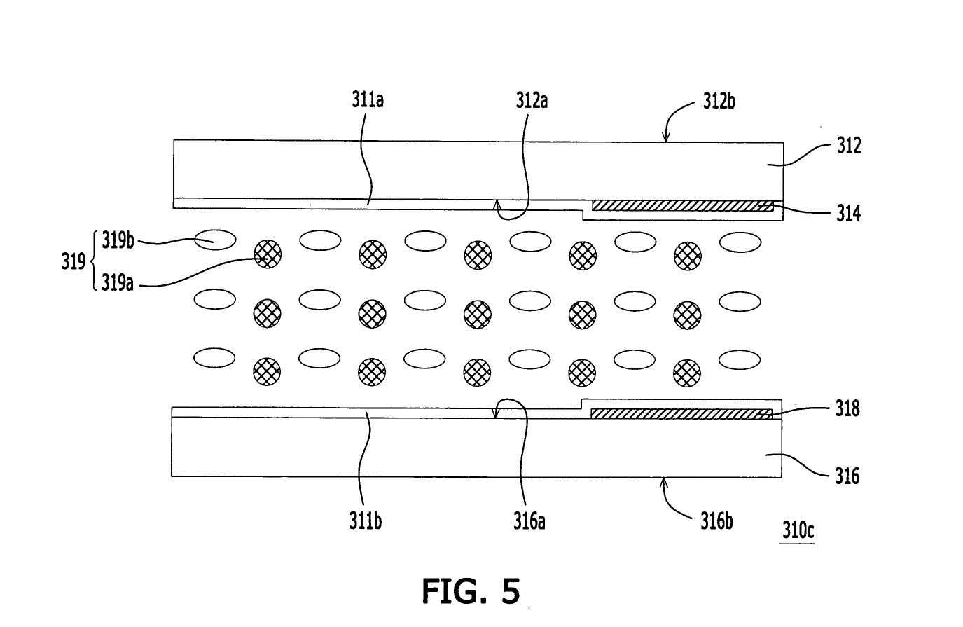

FIG. 5 is a profile diagram of a focus adjustable lens 310c of a light source module according to another embodiment of the present invention when no voltage is applied. Referring to FIG. 5, the focus adjustable lens 310c of the embodiment of the present invention is similar to the above mentioned focus adjustable lens 310 (shown as FIG. 2D), and the differences between the both are described below. The focus adjustable lens 310c further includes a first orientation film 311a and a second orientation film 311b. The first orientation film 311a is disposed between the first light transmissive plate 312 and the focus adjustable solution 319, and the second orientation film 311b is disposed between the second light transmissive plate 316 and the focus adjustable solution 319. In the embodiment of the present invention, the electrotaxis solute 319b of the focus adjustable solution 319 includes a liquid crystal, and the first orientation film 311a and the second orientation film 311b may cause the arrangement of the liquid crystal molecule to have directivity. Besides, in the embodiment of the present invention, the first orientation film 311a may cover the first electrode 314, and the second orientation film 311b may cover the second electrode 318.

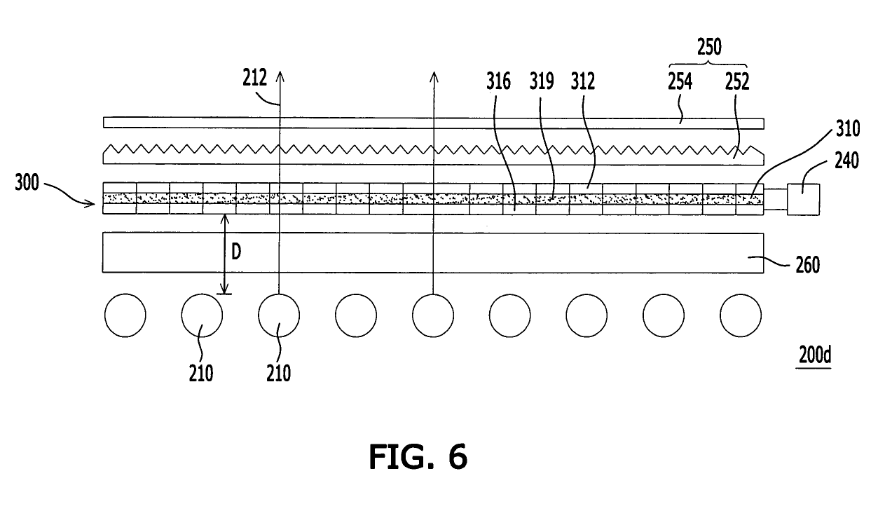

FIG. 6 is a structural diagram of a light source module according to another embodiment of the present invention. The light source module 200d of the embodiment of the present invention is similar to the above mentioned light source module 200 (shown as FIG. 2A), and the differences between the light source module 200d and the light source module 200 are described below. The light source module 200d includes a plurality of the light emitting devices 210, and the shortest distance D of each of the light emitting devices 210 to the focus adjustable lens array 300 is along a direction substantially perpendicular to the focus adjustable lens array 300. In other words, the light source module 200d is a direct type light source module. In the embodiment of the present invention, the light source module 200d further includes a diffusion plate 260 disposed in the transmission path of the light beam 212, wherein the focus adjustable lens array 300 is disposed on the diffusion plate 260. In addition, the optical film 250 is disposed in the transmission path of the light beam 212. However, in another embodiment of the present invention, the light source module 200d may not have the optical film 250. Notably, at least one part of the focus adjustable lenses 310 of the light source module 200d may also be replaced by the above mentioned focus adjustable lenses (such as the focus adjustable lens 310a, 310b, and 310c) of the other embodiments of the present invention to form other kinds of light source module.

Above all, the light source module in the embodiment of the present invention adopts the focus adjustable lens array having the focus adjustable solution. When the light intensity distribution of the surface light source provided by the light source module needs to change according to the users' requirements or the revision of the light source module, the voltage applied between the first electrode and the second electrode of the focus adjustable lenses may be respectively changed, and the distribution of the electrotaxis solute in the focus adjustable solution is change, such that the distribution of the refractive index of the focus adjustable solution is changed. As a result, the light intensity distribution of the surface light source may be changed, and the light source module in the embodiment of the present invention has an efficacy of adjusting the light intensity distribution on real-time. Therefore, the light source module may be adjusted according to the users' requirement, and different light emitting types of light source modules may not be purchased additionally. In addition, when the light source module revises, the distribution of the optical micro structures on the light guide plate may not need to redesign, and only the voltage applied between the first electrode and the second electrode needs to change. In this way, the design cost and the time of design and manufacturing for the revised light source module may be reduced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source module, comprising:
at least one light emitting device, adapted to emit a light beam; and
a focus adjustable lens array, disposed in the transmission path of the light beam, the focus adjustable lens array comprising a plurality of focus adjustable lenses arranged in an array, and each of the focus adjustable lenses comprising:
a first light transmissive plate, disposed in the transmission path of the light beam;
a first electrode, disposed on a peripheral area of the first light transmissive plate, wherein the peripheral area of the first light transmissive plate is capable of circling the central area of the first light transmissive plate;
a second light transmissive plate, disposed in the transmission path of the light beam, wherein the distance from the light emitting device to the second light transmissive plate is shorter than the distance from the light emitting device to the first light transmissive plate;
a second electrode, disposed on a peripheral area of the second light transmissive plate, wherein the peripheral area of the second light transmissive plate is capable of circling the central area of the second light transmissive plate; and
a focus adjustable solution, disposed between the first light transmissive plate and the second light transmissive plate, the focus adjustable solution comprising:
a solvent; and
an electrotaxis solute, mixed into the solvent, wherein the electrotaxis of the electrotaxis solute is greater than the electrotaxis of the solvent, and an absolute value of the difference between the refractive index of the electrotaxis solute and the refractive index of the solvent is greater than zero, when a voltage is applied between the first electrode and the second electrode, an electric field through the focus adjustable solution is generated, and the electrotaxis solute is adjacent from the weak electric field to the strong electric field.

2. The light source module as claimed in claim 1, wherein the electrotaxis solute of each of the focus adjustable lenses comprises a liquid crystal, a sodium ion or a chlorine ion.

3. The light source module as claimed in claim 1, wherein the solvent of each of the focus adjustable lenses comprises an organic monomer.

4. The light source module as claimed in claim 1, further comprising a light guide plate disposed in the transmission path of the light beam, the light guide plate having a first surface facing towards the focus adjustable lens array, a second surface opposite to the first surface, and a light incident surface connecting the first surface and the second surface, wherein the light beam is incident into the light guide plate through the light incident surface, the light beam is capable of exiting the light guide plate through the first surface, and the light beam is transmitted into the focus adjustable lens array.

5. The light source module as claimed in claim 4, further comprising an optical film disposed in the transmission path of the light beam, wherein the light beam is capable of passing through the light guide plate and then passing through the optical film, and the optical film comprises at least one of a brightness enhancement film and a diffusion plate.

6. The light source module as claimed in claim 1, wherein the at least one light emitting device is a plurality of light emitting devices, and the shortest distance from each of the light emitting devices to the focus adjustable lens array is along a direction substantially perpendicular to the focus adjustable lens array.

7. The light source module as claimed in claim 6, further comprising a diffusion plate disposed in the transmission path of the light beam, wherein the focus adjustable lens array is disposed on the diffusion plate.

8. The light source module as claimed in claim 6, further comprising an optical film disposed in the transmission path of the light beam, wherein the optical film comprises at least one of a brightness enhancement film and a diffusion plate.

9. The light source module as claimed in claim 1, wherein in each of the focus adjustable lenses, the first electrode is disposed between the first light transmissive plate and the focus adjustable solution, the second electrode is disposed between the second light transmissive plate and the focus adjustable solution, and the second electrode is disposed between the first electrode and the second light transmissive plate.

10. The light source module as claimed in claim 1, wherein in at least one of the focus adjustable lenses, the first electrode is capable of surrounding the central area of the first light transmissive plate and the second electrode is capable of surrounding the central area of the second light transmissive plate.

11. The light source module as claimed in claim 1, wherein in at least one of the focus adjustable lenses, the first electrode is disposed on a part of the peripheral area of the first light transmissive plate and does not surround the central area of the first light transmissive plate, and the second electrode is disposed on a part of the peripheral area of the second light transmissive plate and does not surround the central area of the second light transmissive plate.

12. The light source module as claimed in claim 1, wherein in each of the focus adjustable lenses, the first electrode and the second electrode are each a light transmissive electrode.

13. The light source module as claimed in claim 1, wherein in each of the focus adjustable lenses, the first transmissive plate has a third surface facing towards the focus adjustable solution and a fourth surface opposite to the third surface, the second transmissive plate has a fifth surface facing towards the focus adjustable solution and a sixth surface opposite to the fifth surface, and at least one of the third surface, the fourth surface, the fifth surface, and the sixth surface is a curved surface.

14. The light source module as claimed in claim 1, wherein in each of the focus adjustable lenses, the first transmissive plate has a third surface facing towards the focus adjustable solution and a fourth surface opposite to the third surface, the second transmissive plate has a fifth surface facing towards the focus adjustable solution and a sixth surface opposite to the fifth surface, and at least one of the third surface, the fourth surface, the fifth surface, and the sixth surface is a plane surface.

15. The light source module as claimed in claim 1, wherein in each of the focus adjustable lenses, the electrotaxis solute comprises a liquid crystal, and each of the focus adjustable lenses further comprises:
a first orientation film, disposed between the first light transmissive plate and the focus adjustable solution; and
a second orientation film, disposed between the second light transmissive plate and the focus adjustable solution.

16. The light source module as claimed in claim 1, wherein in each of the focus adjustable lenses, the absolute value of the difference between the refractive index of the electrotaxis solute and the refractive index of the solvent is less than or equal to 1.5.

17. The light source module as claimed in claim 1, further comprising a voltage control unit electrically connected to the first electrodes and the second electrodes of the focus adjustable lenses.
